(19) United States
(12) Patent Application Publication
(10) Pub. No.: US 2017/0132426 A1
(43) Pub. Date: May 11, 2017

(54) CONTROL SYSTEM OF THE IMAGE DATA STORED IN THE MEMORY CARD

(71) Applicant: BARUN ELECTRONICS CO., LTD., HWASEONG-SI (KR)

(72) Inventor: JAE HYUN LEE, PYEONGTAEK-SI (KR)

(21) Appl. No.: 15/341,212

(22) Filed: Nov. 2, 2016

(30) Foreign Application Priority Data
Nov. 5, 2015 (KR) 10-2015-0155380

(51) Int. Cl. G06F 21/62; G06T 11/60; H04N 1/00; G06T 1/00; H04N 5/907

(52) U.S. Cl. CPC G06F 21/6218; G06T 1/0007; H04N 5/907; H04N 1/00204; H04N 1/00875; G06T 11/60

(57) ABSTRACT

A control system of image data stored in a memory card is provided. The system includes an image storing unit to store image data recorded by an image recorder after passing user authentication; a reading unit to connect a host computer or a PC with the image storing unit to read the image data; and a control unit to authenticate use by receiving information of the image storing unit, and play and edit the image data.

### CROSS-REFERENCE TO RELATED APPLICATION

This U.S. non-provisional patent application claims priority under 35 U.S.C. §119 to Korean Patent Application No. 10-2015-0155380, filed on Nov. 5, 2015 in the Korean Intellectual Property Office, the disclosure of which is hereby incorporated by reference in its entirety.

### BACKGROUND

The present invention relates to a control system or image data stored in a memory card and method of control the same, more specifically, relates to a control system or image data stored in a memory card capable of playing the image data stored in the memory card on a PC, a host computer, a mobile terminal, etc. using a reader. However, image editing is excluded to protect the image data and prevent information from being exposure unless a predetermined password is not inputted.

Generally, in a society where larceny, violence, traffic accident and etc. are frequently occurred, people are using digital devices such as a smart phone, a CCTV, a black box and etc. with an image recorder capable of remaining evidences quickly in an accident as well as preventing an accident.

The image data recorded in the digital devices with the image recorder are stored in a memory card installed in the digital devices and played on a PC, a mobile terminal and etc. using a memory card reader.

In accessing to the image data, however, an unspecified person can edit or delete the image data to damage the image data without any exclusion.

In addition, there is a problem that the image data recorded by a CCTV or a black box which is an important evidence for most of accidents occurred at a load or an alley is edited or deleted because of an easy access. Therefore, the image data is not used as evidence.

Related art is Korean patent publication No. 10-2007-0015853 “SECURITY SYSTEM OPERATABLE ON THE PORTABLE STORAGE DEVICE BY USB INTERFACE”, Feb. 6, 2007 and Korean patent publication No. 10-2007-0015853 “MEMORY CARD WITH DUAL INTERFACES AND THE TRANSFERRING MODULE THEREOF”, Jun. 15, 2001.

### SUMMARY

Embodiments of the inventive concept provide a control system of image data stored in a memory card and a method of the same in which the image data stored in the memory card is not edited and deleted without input a predetermined password thereby the image data stored in the memory card is excluded editing without password input to protect the image data and prevent information from exposure but played on a PC, a host computer or a mobile terminal using a reader.

Embodiments of the inventive concept provide a control system of image data stored in a memory card. The system comprises an image storing unit to store image data recorded by an image recorder after passing user authentication; a reading unit to connect a host computer or a PC with the image storing unit to read the image data; and a control unit to authenticate use by receiving information of the image storing unit, and play and edit the image data.

In some embodiments, the system may further comprise a storage server to store the image data independently. The image data may be stored in the storage server and controlled.

In other embodiments, a storing period of the image data may be changed by a user setting.

In still other embodiments, the image storing unit may be at least one of a SD card, a memory stick, an xD picture card, a MMC card or a CF card.

In even other embodiments, the control unit may assign a password for approving the image data edit when the image storing unit is authenticated to use, and the password may be inputted whenever the image data is edited.

In yet other embodiments, a partition of the image storing unit may be assigned to at least one of time, day, date, case or event.

### BRIEF DESCRIPTION OF THE DRAWINGS

The inventive concepts will become more apparent in view of the attached drawings and accompanying detailed description.

FIG. 1 is a flow chart of a control system of image data stored in a memory card according to an embodiment of the inventive concept.

FIG. 2 is a drawing illustrating an embodiment of the inventive concept according to FIG. 1

### DETAILED DESCRIPTION OF THE EMBODIMENTS

The inventive concepts will now be described more fully hereinafter with reference to the accompanying drawings, in which exemplary embodiments of the inventive concepts are shown. The advantages and features of the inventive concepts and methods of achieving them will be apparent from the following exemplary embodiments that will be described in more detail with reference to the accompanying drawings. It should be noted, however, that the inventive concepts are not limited to the following exemplary embodiments, and may be implemented in various forms. Accordingly, the exemplary embodiments are provided only to disclose the inventive concepts and let those skilled in the art know the category of the inventive concepts. In the drawings, embodiments of the inventive concepts are not limited to the specific examples provided herein and are exaggerated for clarity.

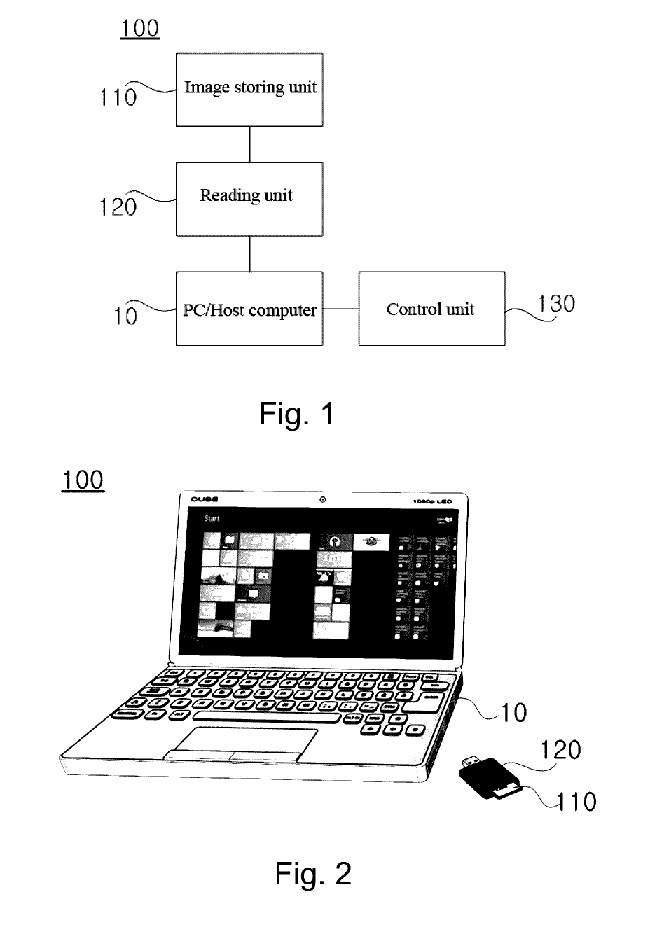

FIG. 1 is a flow chart of a control system of image data stored in a memory card according to an embodiment of the inventive concept, and FIG. 2 is a drawing illustrating an embodiment of the inventive concept according to FIG. 1

As shown in FIGS. 1 and 2, a control system 100 of image data stored in a memory card according to embodiments of the inventive concept may include an image storing unit 110, a reading unit 120 and a control unit 130.

The control system 100 of image data stored in a memory card may further include a storage server 140 storing the image data independently to store and control the image data separately.

The image data may be stored in the storage server 140 according to user's setting up.

The image data in the image storing unit 110 connected with the control unit 130 may be duplicated and uploaded to the storage server 140 according to storing or not. The image data uploaded in the storage server 140 may not be received and played as well as edited and deleted without a special permission.

A user can set up an expiration time of the image data stored in the storage server 140, and the image data may be deleted permanently after the expiration time.

The image storing unit 110 may store the image data recorded by the image recorder after passing user authentication.

The image storing unit 110 may be restricted to store the image data recorded by the image recorder without user authentication.

The image storing unit 110 may be at least one of a SD card, a memory stick, an xD picture card, a MMC card or a CF card.

The memory card may be classified by in capacity or speed according to types, the SD card is similar with the MMC card in appearance, but has higher data transmission speed and copyright protect standard.

A SDHC (SD high capacity) is a memory card which makes up for the weak points in the SD card to have large capacity.

A SDXC which makes up for the weak points in the SDHC can be available for the exFAT file system and has more capacity and faster transmitting speed.

The memory stick may be referred as ‘MS’ in abbreviation and may be used for Sony devices such as a cyber shot digital cameras, VAIO notebooks, PSP game devices and etc.

The xD picture card is developed for digital camera and classified into normal type M, 1.5× speed type M+ and 3× speed type H according the data transmitting speed.

The MMC card is an abbreviation of Multi Media Card, has been frequently used in an early digital cameras or PDAs.

The MMC card is the same as the SD card in size and usage, thereby the devices with SD card slot is frequently compatible with MMC.

The CF card is an abbreviation of Compact Flash and has a controller therein. Thus products with high capacity and high performance may be produced easily in accordance with manufacturer ability and has relatively low compatible problem with devices.

The reading unit 120 may connect the image storing unit 110 with a host computer or a PC to read the image data.

The reading unit 120 may be a memory card reader, Varieties of memory card may be inserted into the memory card reader, thereby using the memory card to transmit data to a PC or write data from the PC in the memory card. Although it is collect to refer a reader/writer since reading and writing data are available, it is called as a reader in convenience.

The control unit 130 may receive information of the image storing unit 110, authenticate use, play and edit the image data.

The control unit 130 may be a firmware which is a program to control the image storing unit 110 in the form of a hardware to control editing, deleting and etc. of the image data stored in the image storing unit 110.

When the image storing unit 110 is inserted into the reading unit 120 to connect with the control unit 130, the control unit 130 may request information such as a user ID, password and etc., and then information such as an identification number on a surface of the image storing unit 110 when the user information is inputted.

When the requested information of the image storing unit 110 is inputted, the information of the user and the image storing unit 110 is stored in the control unit 130 to make possible management such as editing or playing the image data in the image storing unit 110 and take a measure against loss or damage of the image data such as duplicating and storing the image data into the storage server 140.

When the image storing unit 110 is authenticated to use, the control unit 130 may assign a password for edit permission of the image data and the assigned password may be inputted whenever the image data is edited.

The control unit 130 may play the image data without the password for edit permission. Although the image data is playing, an operation is restricted and a caution message of password input and a password input window are displayed when a mouse is clicked right button on the image data or the action is attempted to put out the image data in the image storing unit 110 by force.

When the image data is edited after storing the image storing unit 110 and the user information, a password for edit permission is assigned to get a right for image data editing and then the image storing unit 110 is inserted into the image reading device to store the image data.

For example, when the image data is stored to the image storing unit 110, it may be restricted to store the image data unless at least one step of user information input, image storing unit information input or edit permission password is not completed.

The control unit 130 may assign the partition of the image storing unit 110 to at least one of time, day, date, case or event.

The image data recorded by a CCTV may be generally divided into partitions in basis of time. In case of black box, the image data may be stored by events or stored for a recording time while a user records the image in force.

However, if the control unit 130 sets up at least one of time, day, date, case or event in accordance with user selection, the image storing unit 110 is divided by partitions in the basis and store the image data. Therefore, the image data can be found easily at a time of editing or playing.

According to the embodiments of the inventive concept, the control system of the image data stored in the memory card and the method of the same may be provided to prevent the image data stored in the memory card from editing and deleting without predetermined password input. Although the image data stored in the memory card is played on a PC, a host computer, a mobile terminal and etc., image editing may be excluded to protect the image data and prevent the information from exposure unless the predetermined password input.

According to the embodiments of the inventive concept, the stirring and ageing process is sequentially processed in the reactor, and more specifically the heating unit heats the reactor at the temperatures necessary for the stirring and ageing process sequentially. Thus, time for manufacturing process can be steeply reduced without transferring the mixed solution by processes like conventional arts.

Further, according to the embodiments of the inventive concept, the capacity of the reactor can be increased as occasion demands to manufacture the mesoporous silica in large quantities.

While the inventive concepts have been described with reference to example embodiments, it will be apparent to those skilled in the art that various changes and modifications may be made without departing from the spirits and scopes of the inventive concepts. Therefore, it should be understood that the above embodiments are not limiting, but illustrative. Thus, the scopes of the inventive concepts are to be determined by the broadest permissible interpretation of the following claims and their equivalents, and shall not be restricted or limited by the foregoing description.

What is claimed is:

1. A control system of image data stored in a memory card comprising:
an image storing unit to store image data recorded by an image recorder after passing user authentication;
a reading unit to connect a host computer or a PC with the image storing unit to read the image data; and
a control unit to authenticate use by receiving information of the image storing unit, the control unit playing and editing the image data.

2. The system of claim 1, further comprising:
a storage server to store the image data independently,
wherein the image data is stored in the storage server and controlled.

3. The system of claim 2, wherein a storing period of the image data is changed by a user setting.

4. The system of claim 1, wherein the image storing unit is at least one of a SD card, a memory stick, a xD picture card, a MMC card or a CF card.

5. The system of claim 1, wherein the control unit assigns a password for approving the image data edit when the image storing unit is authenticated to use, and the password is inputted whenever the image data is edited.

6. The system of claim 1, wherein a partition of the image storing unit is assigned to at least one of time, day, date, case or event.
